(19) United States
(12) Patent Application Publication
(10) Pub. No.: US 2018/0046849 A1
(43) Pub. Date: Feb. 15, 2018

(54) AUTHENTICATION DEVICE, IMAGE PROCESSING APPARATUS, AND AUTHENTICATION METHOD

(71) Applicant: KYOCERA Document Solutions Inc., Osaka (JP)

(72) Inventors: Kris-Antonette Lapiz, Osaka (JP); Michael Jason Aguilar, Cebu (PH); Gilmore Capiral, Cebu (PH); Katrina Star Casera, Osaka (JP)

(21) Appl. No.: 15/279,270

(22) Filed: Sep. 28, 2016

(30) Foreign Application Priority Data
Aug. 12, 2016 (JP) 2016-158374

(51) Int. Cl. G06K 9/00; G06F 3/041

(52) U.S. Cl. CPC G06K 9/00181; G06K 9/00194; G06F 3/0412; G06K 2209/27; G06F 2203/04104

(57) ABSTRACT

An authentication device includes an operation panel, a registered handwriting procedure acquiring portion, a long-pressing detecting portion, a handwriting detecting portion, and a handwriting authentication portion. The registered handwriting procedure acquiring portion acquires information of a registered handwriting procedure from a storage portion in which the information of the registered handwriting procedure has been stored, which represents a handwriting procedure including a trajectory of a handwriting operation performed on the operation panel and at least one of a time, a speed, and a number of strokes of the handwriting operation. The handwriting detecting portion detects the handwriting procedure in the handwriting operation performed on the operation panel, during a period in which the long-pressing operation is continuously detected. The handwriting authentication portion determines whether the detected handwriting procedure satisfies a predetermined approximation condition with respect to the acquired registered handwriting procedure, thereby determining whether authentication has succeeded or failed.

### INCORPORATION BY REFERENCE

This application is based upon and claims the benefit of priority from the corresponding Japanese Patent Application No. 2016-158374 filed on Aug. 12, 2016, the entire contents of which are incorporated herein by reference.

### BACKGROUND

The present disclosure relates to authentication devices, image processing apparatuses, and authentication methods.

Generally, an image processing apparatus such as an image forming apparatus or an image reading apparatus includes a touch panel in which an operation panel and a display portion are integrated. In this case, when the image processing apparatus performs an authentication process, a password input through an operation performed on the operation panel is checked against a pre-registered password.

Meanwhile, there are cases where input information required for the authentication process is input by a handwriting operation performed on the operation panel. For example, it has been known that, in the authentication process, a trajectory of a handwriting operation performed on the operation panel is detected, and the detected trajectory is checked against a trajectory represented by pre-registered data in a pattern recognition process.

In the above-described case, the following operations are required: a screen call operation such as tapping an input start button displayed on the display portion; a handwriting operation performed on a handwriting input screen that is displayed on the display portion in response to the screen call operation; and an authentication start operation for starting the authentication process by deleting the handwriting input screen.

In the authentication process described above, it is troublesome for a user to perform the authentication start operation after the password input operation or the handwriting operation.

In addition, in the authentication process based on checking of a password, input of a long password is required to enhance the security. However, an operation of inputting a long password is troublesome.

Meanwhile, in the authentication process based on checking of the trajectory of a handwriting operation, if a strict matching condition is adopted for the checking in order to enhance the security, authentication failure may occur excessively frequently.

On the other hand, in checking the trajectory of the handwriting operation, if an approximation condition having a relatively wide allowable range is adopted, a handwriting operation having a complicated trajectory is required in order to enhance the security. It is troublesome to perform the handwriting operation having the complicated trajectory.

An objective of the present disclosure is to provide an authentication device capable of performing a high-security authentication process by a simple operation, an image processing apparatus including the authentication device, and an authentication method using the authentication device.

### SUMMARY

An authentication device according to one aspect of the present disclosure includes an operation panel, a registered handwriting procedure acquiring portion, a long-pressing detecting portion, a handwriting detecting portion, and a handwriting authentication portion. The operation panel is capable of detecting a multi-touch operation. The registered handwriting procedure acquiring portion acquires information of a registered handwriting procedure from a storage portion in which the information of the registered handwriting procedure has been stored in advance. The registered handwriting procedure represents a handwriting procedure including a trajectory of a handwriting operation performed on the operation panel and at least one of a time, a speed, and a number of strokes of the handwriting operation. The long-pressing detecting portion detects a long-pressing operation performed on the operation panel. The handwriting detecting portion detects the handwriting procedure in the handwriting operation performed on the operation panel, during a period in which the long-pressing operation is continuously detected. The handwriting authentication portion determines whether or not the detected handwriting procedure satisfies a predetermined approximation condition with respect to the acquired registered handwriting procedure, thereby determining whether authentication has succeeded or failed.

An image processing apparatus according to another aspect of the present disclosure includes an image processing portion and the above-described authentication device. The image processing portion includes one or both of an image reading portion configured to read an image of a document sheet and an image forming portion configured to form an image on a sheet.

An authentication method according to still another aspect of the present disclosure includes acquiring information of a registered handwriting procedure from a storage portion in which the information of the registered handwriting procedure has been stored in advance. The registered handwriting procedure represents a handwriting procedure including a trajectory of a handwriting operation performed on an operation panel capable of detecting a multi-touch operation and at least one of a time, a speed, and a number of strokes of the handwriting operation. Further, the authentication method includes detecting a long-pressing operation performed on the operation panel. Further, the authentication method includes detecting the handwriting procedure in the handwriting operation performed on the operation panel, during a period in which the long-pressing operation is continuously detected. Further, the authentication method includes determining whether or not the detected handwriting procedure satisfies a predetermined approximation condition with respect to the acquired registered handwriting procedure, thereby determining whether authentication has succeeded or failed.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram of an image processing apparatus according to an embodiment.

FIG. 2 is a flowchart showing an example of procedure of an authentication information registration process in the image processing apparatus according to the embodiment.

FIG. 3 is a flowchart showing an example of procedure of a login process in the image processing apparatus according to the embodiment.

FIG. 4 shows an example of an authentication information registration screen in the image processing apparatus according to the embodiment.

FIG. 5 shows an example of an authentication information registration screen on which a virtual keyboard is displayed, in the image processing apparatus according to the embodiment.

FIG. 6 shows an example of an authentication information registration screen on which a handwriting operation is performed, in the image processing apparatus according to the embodiment.

FIG. 7 shows an example of a login screen in the image processing apparatus according to the embodiment.

FIG. 8 shows an example of a login screen on which a handwriting frame is displayed, in the image processing apparatus according to the embodiment.

FIG. 9 shows an example of a login screen on which a handwriting operation is performed, in the image processing apparatus according to the embodiment.

FIG. 10 shows an example of a login screen on which a handwriting authentication error occurs, in the image processing apparatus according to the embodiment.

FIG. 11 shows an example of a login screen on which a virtual keyboard is displayed, in the image processing apparatus according to the embodiment.

### DETAILED DESCRIPTION

Hereinafter, embodiments of the present disclosure will be described with reference to the accompanying drawings. It should be noted that the following embodiments are examples embodying the present disclosure, and, by nature, do not limit the technical scope of the present disclosure.

[Configuration of Image Processing Apparatus 10]

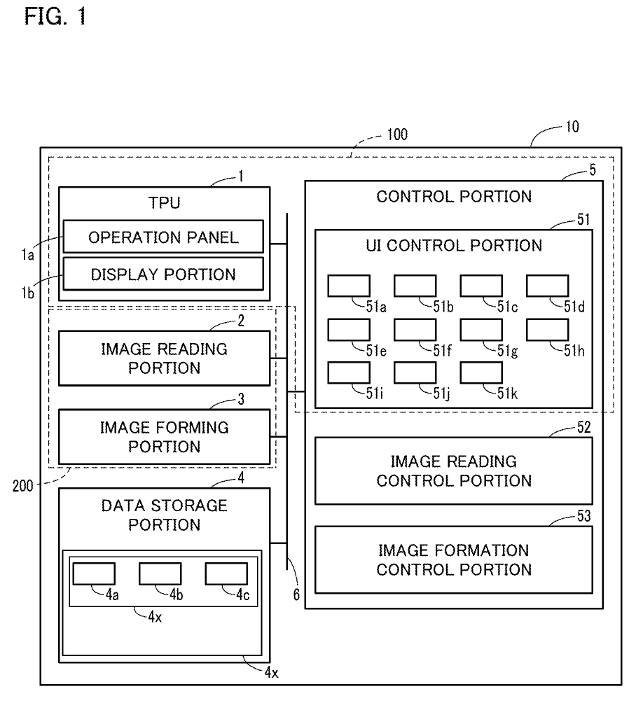

As shown in FIG. 1, an image processing apparatus 10 according to an embodiment includes a touch panel unit (TPU) 1, an image reading portion 2, an image forming portion 3, a data storage portion 4, a control portion 5, and the like. The TPU 1 includes an operation panel 1a and a display portion 1b which are integrated with each other.

The operation panel 1a is a panel capable of detecting a multi-touch operation. For example, a capacitive, resistive, or optical operation panel 1a may be adopted. The display portion 1b is a panel-like display device such as a liquid crystal panel.

The image reading portion 2 is a device executing an image scanning process of reading an image of a document sheet. For example, the image reading portion 2 includes: a platen glass on which a document sheet is placed; a light source that emits light toward the document sheet; a mechanism that causes the light source to move along the platen glass; a line sensor that receives reflected light from the document sheet and outputs image data; and the like.

The image forming portion 3 is a device that executes a printing process of forming an image on a sheet by a predetermined method such as electrophotography or ink jetting. For example, the image forming portion 3 forms, on the sheet, an image represented by image data obtained by the image reading portion 2.

In the present embodiment, the image reading portion 2 and the image forming portion 3 form an image processing portion 200. Alternatively, the image processing portion 200 may include only one of the image reading portion 2 and the image forming portion 3.

The data storage portion 4 is a non-transitory computer-readable memory. For example, a hard disk drive, a flash memory, or the like is adopted as the data storage portion 4.

The control portion 5 executes various types of calculation and data processing, and controls various electronic devices included in the image processing apparatus 10. The control portion 5 is capable of exchanging data and control signals with the TPU 1, the image reading portion 2, the image forming portion 3, and the data storage portion 4 via a bus 6.

The control portion 5 includes a user interface (UI) control portion 51 that controls the TPU 1, an image reading control portion 52 that controls the image reading portion 2, an image formation control portion 53 that controls the image forming portion 3, and the like. The UI control portion 51 controls the TPU 1, and executes an authentication information registration process, a login process, and the like which are described later.

For example, the control portion 5 is implemented by a processor that executes a program stored in the data storage portion 4 or the like in advance. The processor is a microprocessor unit (MPU), a digital signal processor (DSP), or the like.

When the UI control portion 51 detects that a predetermined scan start operation is performed on the TPU 1, the image reading control portion 52 causes the image reading portion 2 to execute the image scanning process. In addition, when the UI control portion 51 detects that the predetermined copy start operation is performed on the TPU 1, the image reading control portion 52 causes the image reading portion 2 to execute the image scanning process, and the image formation control portion 53 causes the image forming portion 3 to execute the printing process.

The UI control portion 51 includes a registration control portion 51a, a touch operation detecting portion 51b, a character string input control portion 51c, an ID overlap check portion 51d, a handwriting frame display control portion 51e, a handwriting detecting portion 51f, a detection result display control portion 51g, a login control portion 51h, a registration information acquiring portion 51i, a handwriting authentication portion 51j, a password authentication portion 51k, and the like.

The login process is a process of determining whether or not to allow a user to use the image processing apparatus 10, on the basis of input authentication information that is input through the TPU 1. The login process is an example of an authentication process. The authentication information registration process is a process of causing the data storage portion 4 to store registered authentication information 4x to be compared to the input authentication information, in advance of the login process.

In the image processing apparatus 10, the TPU 1 and the UI control portion 51 form an authentication device 100 that executes the login process. The authentication device 100 determines whether authentication for use of the image processing portion 200 has succeeded or failed.

In the conventional general authentication device, there are cases where input information required for the login process is input by a handwriting operation performed on the operation panel 1a. For example, it has been known that, in the login process, a trajectory of a handwriting operation performed on the operation panel 1a is detected, and the detected trajectory is checked against a trajectory represented by pre-registered data in a pattern recognition process.

In the above-described case, the following operations are required: a screen call operation such as tapping an input start button displayed on the display portion 1b; a handwriting operation performed on a handwriting input screen that is displayed on the display portion 1b in response to the screen call operation; and an authentication start operation for starting the login process by deleting the handwriting input screen.

In the login process described above, it is troublesome for the user to perform the authentication start operation after a password input operation or a handwriting operation on the TPU 1.

In addition, in the login process based on checking of a password, input of a long password is required to enhance the security. However, an operation of inputting a long password is troublesome.

Meanwhile, in the log-in process based on checking of the trajectory of a handwriting operation, if a strict matching condition is adopted for the checking in order to enhance the security, authentication failure may occur excessively frequently.

On the other hand, in checking the trajectory of the handwriting operation, if an approximation condition having a relatively wide allowable range is adopted, a handwriting operation having a complicated trajectory is required in order to enhance the security. It is troublesome to perform the handwriting operation having the complicated trajectory.

The authentication device 100 according to the present embodiment is capable of performing the login process with high security by a simple operation. Hereinafter, the authentication information registration process and the login process by the authentication device 100 will be described.

[Authentication Information Registration Process]

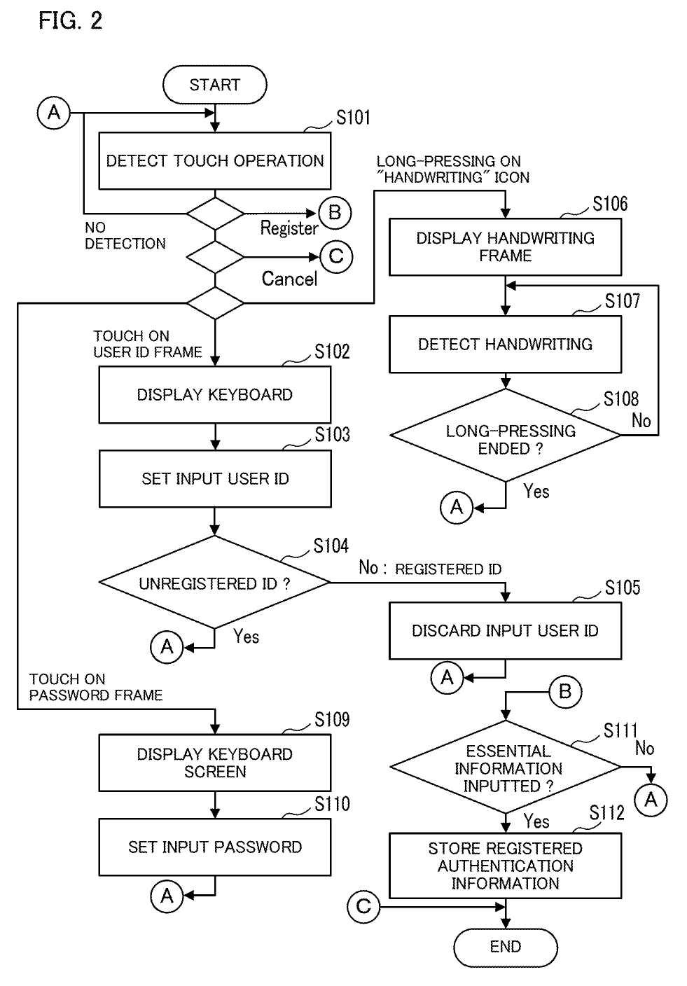

First, an example of procedure of the authentication information registration process by the authentication device 100 will be described with reference to a flowchart shown in FIG. 2. In the following description, S101, S102, . . . represent identification characters for respective steps performed by the UI control portion 51.

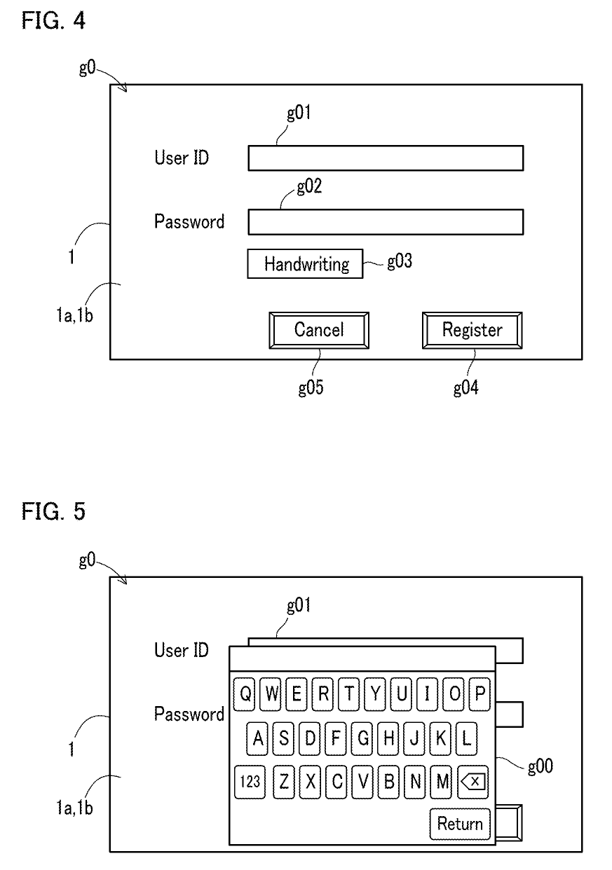

When a predetermined registration start operation is performed on the operation panel 1a or an operation button (not shown), the registration control portion 51a of the UI control portion 51 causes an authentication information registration screen g0 to be displayed (refer to FIG. 4). Thus, the authentication information registration process is started.

As shown in FIG. 4, the authentication information registration screen g0 includes a user ID input frame g01, a password input frame g02, a “handwriting” icon g03, a “register” icon g04, a “cancel” icon g05, and the like.

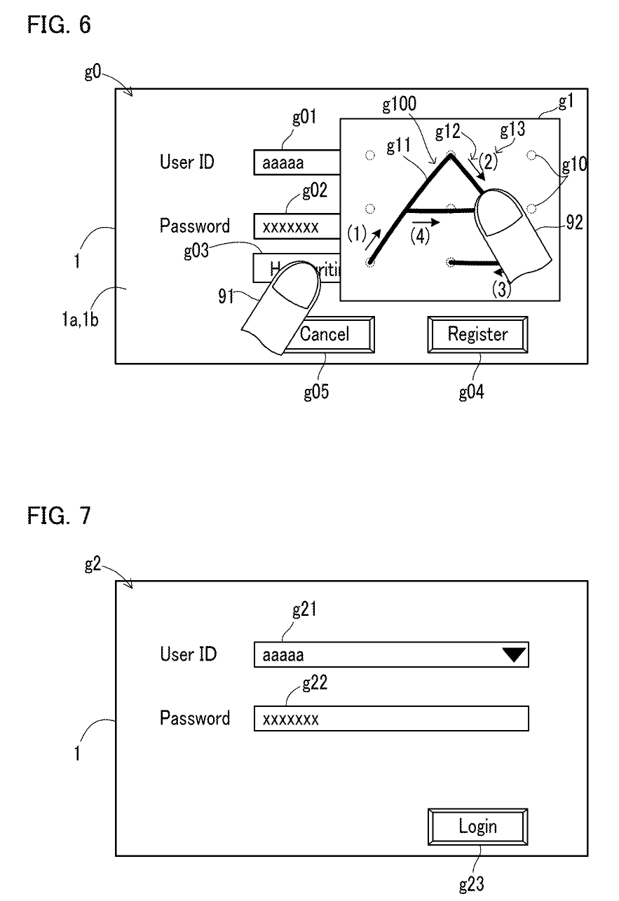

The user ID input frame g01 represents an area that accepts an operation of inputting a user ID such as a user name. The password input frame g02 represents an area that accepts an operation of inputting a password corresponding to the user ID. The “handwriting” icon g03 is an icon to be operated when an operation of inputting a handwritten drawing g100 described later is performed (refer to FIG. 6).

<Step S101>

When the authentication information registration screen g0 is displayed on the display portion 1b, the touch operation detecting portion 51b detects a touch operation performed on the operation panel 1a. At this time, the touch operation detecting portion 51b detects the touch operation on the operation panel 1a while distinguishing among predetermined five types of touch operations corresponding to the authentication information registration screen g0.

The five types of touch operations include: an operation of touching the user ID input frame g01; an operation of touching the password input frame g02; an operation of pressing the “handwriting” icon g03 long; an operation of touching the “register” icon g04; and an operation of touching the “cancel” icon g05.

The long-pressing operation is an operation of continuously touching a certain position on the operation panel 1a for a time period equal to or longer than a predetermined long-pressing period. The touch operation detecting portion 51b repeats the process in step S101 until detecting any of the five types of touch operations.

Upon detecting the operation of touching the user ID input frame g01, the touch operation detecting portion 51b advances the process to step S102. Upon detecting the long-pressing operation performed on the handwriting icon g03, the touch operation detecting portion 51b advances the process to step S106. Upon detecting the operation of touching the password input frame g02, the touch operation detecting portion 51b advances the process to step S109.

Upon detecting the operation of touching the “register” icon g04, the touch operation detecting portion 51b advances the process to step S111. Upon detecting the operation of touching the “cancel” icon g05, the touch operation detecting portion 51b ends the authentication information registration process.

<Step S102>

In step S102, the character string input control portion 51c causes the display portion 1b to display a virtual keyboard g00 for inputting a character string (refer to FIG. 5).

<Step S103>

Further, the character string input control portion 51c sets a character string representing the user ID, in accordance with a key touch operation performed in the area of the virtual keyboard g00 on the operation panel 1a. Hereinafter, the user ID obtained through the key touch operation performed on the virtual keyboard g00 is referred to as an input user ID.

<Step S104>

Subsequently, the ID overlap check portion 51d determines whether or not the input user ID is an unregistered ID that does not match a registered user ID already stored in the data storage portion 4.

Upon determining that the input user ID is an unregistered ID, the ID overlap check portion 51d advances the process to step S101 with the storage of the input user ID being maintained. On the other hand, upon determining that the input user ID is not an unregistered ID, the ID overlap check portion 51d advances the process to step S105.

<Step S105>

In step S105, the ID overlap check portion 51d discards the input user ID set in step S103, and advances the process to step S101.

<Step S106>

In step S106, the handwriting frame display control portion 51e causes the display portion 1b to display a handwriting frame g1 representing an input area for a handwritten drawing g100 (refer to FIG. 6). The handwritten drawing g100 represents the trajectory of the handwriting operation. In the example shown in FIG. 6, the handwriting frame display control portion 51e causes a grid g10 serving as a guide for the position of the handwriting operation to be displayed in the handwriting frame g1.

<Step S107>

Further, the handwriting detecting portion 51f executes a handwriting detection process during a period in which the long-pressing operation on the handwriting icon g03 is continuously detected. The handwriting detection process is a process of detecting the handwriting operation performed in the handwriting frame g1 on the operation panel 1a.

The handwriting operation is a multi-stroke slide-touch operation on the operation panel 1a, and a trajectory g11 of the multi-stroke slide-touch operation represents the handwritten drawing g100.

The user performs the long-pressing operation on the handwriting icon g03 with a first finger 91 that is a finger of his/her one hand, and simultaneously performs the handwriting operation with a second finger 92 that is a finger of the other hand (refer to FIG. 6). The first finger 91 is a finger that first touches the operation panel 1a, and the second finger 92 is a finger that touches the operation panel 1a during a period in which the first finger 91 touches the operation panel 1a.

In the UI control portion 51, the touch operation detecting portion 51b detects the long-pressing operation performed on the operation panel 1a (S101), and the handwriting detecting portion 51f detects the handwriting operation performed on the operation panel 1a during the continuation of the long-pressing operation (S107).

In the handwriting detection process, the handwriting detecting portion 51f detects a handwriting procedure of the handwriting operation. The handwriting procedure includes the trajectory g11 of the handwriting operation, and at least one of the time, the speed, and the number of strokes of the handwriting operation. The handwriting procedure is a part of the authentication information, and substitute information for the password.

In the present embodiment, the handwriting procedure includes the trajectory g11 of the handwriting operation, and at least one of the time, the speed, and the number of strokes of the handwriting operation. For example, the handwriting procedure detected by the handwriting detecting portion 51f may include the trajectory g11 of each stroke in the handwriting operation, one or both of the time and the speed of each stroke in the handwriting operation, and the number of strokes of the handwriting operation.

For example, even when a slide-touch operation that is not apart from the operation panel 1a continues, the handwriting detecting portion 51f detects a position at which the speed of the slide-touch operation becomes zero, as an end position of one stroke and a start position of next one stroke.

In the following description, the handwriting procedure of the handwriting operation, which is detected by the handwriting detecting portion 51f, is referred to as a detected handwriting procedure.

Further, in step S107, the detection result display control portion 51g causes the display portion 1b to display the result of the detection by the handwriting detecting portion 51f. In the example shown in FIG. 6, the detection result display control portion 51g causes the display portion 1b to display, as the result of the detection by the handwriting detecting portion 51f, the trajectory g11 of each stroke of the handwriting operation, an arrow g12 indicating the moving direction of the trajectory g11 of each stroke, and a stroke order g13.

<Step S108>

Meanwhile, the touch operation detecting portion 51b monitors whether or not the long-pressing operation on the handwriting icon g03 continues. The touch operation detecting portion 51b allows the process in step S107 by the handwriting detecting portion 51f during the continuation of the long-pressing operation on the handwriting icon g03. The touch operation detecting portion 51b determines that a time point at which the long-pressing operation on the handwriting icon g03 is no longer detected is an end time point of the handwriting operation.

At least when the long-pressing operation on the handwriting icon g03 is no longer detected, the handwriting frame display control portion 51e deletes the handwriting frame g1 from the authentication information registration screen g0 on the display portion 1b, and advances the process to step S101. At this time, the process is advanced from step S108 to step S101 with the storage of the detected handwriting procedure being maintained.

Also when the state in which the handwriting operation in the handwriting frame g1 is not detected, continues for a predetermined time or more, the handwriting frame display control portion 51e may delete the handwriting frame g1 from the authentication information registration screen g0 on the display portion 1b and advance the process to step S101.

<Step S109>

In step S109, the character string input control portion 51c causes the display portion 1b to display the virtual keyboard g00 for inputting a character string.

<Step S110>

Further, the character string input control portion 51c sets the password in accordance with a key touch operation performed in the area of the virtual keyboard g00 on the operation panel 1a. Hereinafter, the password obtained through the key touch operation on the virtual keyboard g00 is referred to as an input password.

The character string input control portion 51c advances the process to step S101 with the storage of the input password being maintained.

<Step S111>

When a touch operation on the “register” icon g04 is detected, the registration control portion 51a determines whether or not predetermined essential information has already been input in steps S103, S107, and S110. The essential information includes the input user ID obtained in step S103, and at least one of the detected handwriting procedure obtained in step S107 and the input password obtained in step S110.

Upon determining that the essential information has already been input, the registration control portion 51a advances the process to next step S112; otherwise, the registration control portion 51a causes the display portion 1b to display a specified error notification, and then advances the process to step S101.

<Step S112>

In step S112, the registration control portion 51a causes the data storage portion 4 to store the registered authentication information 4x in which the input user ID obtained in step S103 is associated with one or both of the detected handwriting procedure and the input password which are obtained in steps S107 and S110, respectively. Thereafter, the registration control portion 51a ends the authentication information registration process.

The registered authentication information 4x includes a registered user ID 4a corresponding to the input user ID obtained in step S103, and one or both of a registered handwriting procedure 4b corresponding to the detected handwriting procedure obtained in step S107 and a registered password 4c corresponding to the input password obtained in step S110.

[Login Process]

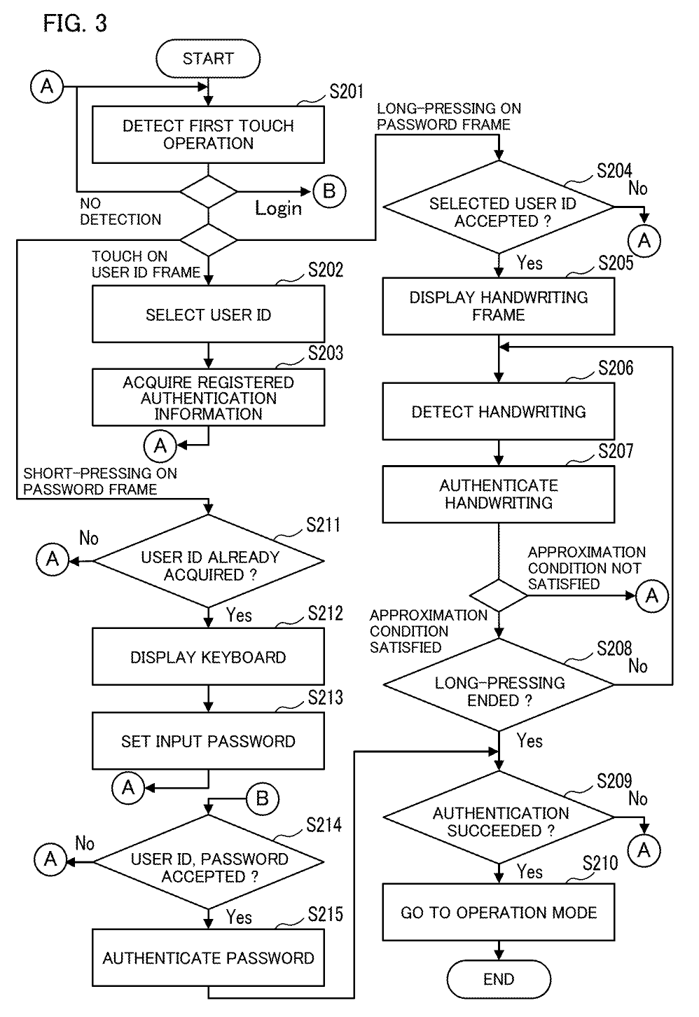

Next, an example of procedure of the login process by the authentication device 100 will be described with reference to a flowchart shown in FIG. 3. In the following description, S201, S202, . . . represent identification characters for respective steps performed by the UI control portion 51.

When the image processing apparatus 10 is started up, the login control portion 51h of the UI control portion 51 causes a login screen g2 to be displayed (refer to FIG. 7). Thus, the login process is started.

As shown in FIG. 7, the login screen g2 includes a user ID input frame g21, a password input frame g22, a “login” icon g23, and the like. The login control portion 51h that causes the display portion 1b to display the login screen g2 including the password input frame g22 is an example of an input frame display control portion.

The user ID input frame g21 represents an area that accepts an operation of inputting the user ID to be used in the login process. The password input frame g22 represents an area that accepts an operation of inputting a password, corresponding to the user ID, to be used in the login process.

<Step S201>

When the login screen g2 is displayed on the display portion 1b, the touch operation detecting portion 51b detects a touch operation performed on the operation panel 1a. At this time, the touch operation detecting portion 51b detects the touch operation on the operation panel 1a while distinguishing among predetermined four types of touch operations corresponding to the login screen g2.

The four types of touch operations include: an operation of touching the user ID input frame g21; a short-pressing operation performed on the password input frame g22; a long-pressing operation performed on the password input frame g22; and an operation of touching the “login” icon g23. The long-pressing operation is an operation of continuously touching an area corresponding to the password input frame g22 on the operation panel 1a for a time period equal to or longer than the long-pressing period described above.

On the other hand, the short-pressing operation is a touch operation shorter in time than the long-pressing operation, and performed on the area corresponding to the password input frame g22 on the operation panel 1a. The touch operation detecting portion 51b repeats the process at step S201 until detecting any of the four types of touch operations.

Upon detecting the operation of touching the user ID input frame g21, the touch operation detecting portion 51b advances the process to step S202. Upon detecting the long-pressing operation performed on the password input frame g22, the touch operation detecting portion 51b advances the process to step S204. Upon detecting the short-pressing operation performed on the password input frame g22, the touch operation detecting portion 51b advances the process to step S211.

Upon detecting the operation of touching the “login” icon g23, the touch operation detecting portion 51b advances the process to step S214.

The touch operation detecting portion 51b that detects the long-pressing operation performed on the password input frame g22 in step S201 is an example of a long-pressing detecting portion that detects the long-pressing operation performed on the operation panel 1a.

In addition, the touch operation detecting portion 51b that detects the short-pressing operation performed on the area corresponding to the password input frame g22 on the operation panel 1a in step S201 is an example of a short-pressing operation detecting portion.

<Step S202>

In step S202, the login control portion 51h selects the user ID to be used in the login process from the registered user IDs 4a included in the registered authentication information 4x, in accordance with a selection operation performed in an area of the user ID input frame g21 on the operation panel 1a. Hereinafter, the registered user ID 4a selected in step S202 is referred to as a selected user ID.

In step S202, the registration information acquiring portion 51i acquires all the registered user IDs 4a from the data storage portion 4, and the login control portion 51h causes the display portion 1b to display all the registered user IDs 4a as selection candidates.

<Step S203>

Further, the registration information acquiring portion 51i acquires, from the data storage portion 4, the registered handwriting procedure 4b and the registered password 4c corresponding to the selected user ID. Thereafter, the login control portion 51h advances the process to step S201.

The registration information acquiring portion 51i that executes the process in step S203 is an example of a registered handwriting procedure acquiring portion that acquires information of the registered handwriting procedure 4b from the data storage portion 4 in which the information of the registered handwriting procedure 4b representing the handwriting procedure has been stored in advance.

In addition, the registration information acquiring portion 51i that executes the process in step S203 is also an example of a registered password acquiring portion that acquires the registered password 4c from the data storage portion 4 in which the registered password 4c associated with the information of the registered handwriting procedure 4b has been stored in advance.

<Step S204>

When the long-pressing operation on the password input frame g22 is detect, the login control portion 51h determines whether or not the selected user ID has already been accepted in the process in step S202. Upon determining that the selected user ID has already been accepted, the login control portion 51h advances the process to next step S205; otherwise, the login control portion 51h causes the display portion 1b to display a specified error notification, and advances the process to step S201.

<Step S205>

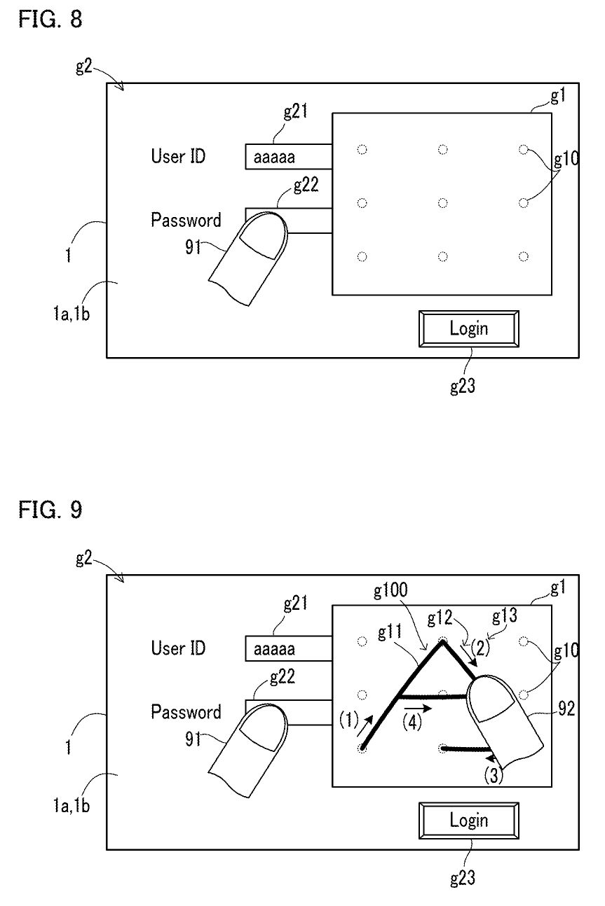

In step S205, the handwriting frame display control portion 51e causes the display portion 1b to display the handwriting frame g1 representing an input area for the handwritten drawing g100 (refer to FIG. 8). The process in step S205 is executed when the long-pressing operation on the password input frame g22 is detected.

<Step S206>

Further, similarly to step S107 in FIG. 2, the handwriting detecting portion 51f executes the handwriting detection process during a period in which the long-pressing operation on the password input frame g22 is continuously detected. At this time, the handwriting detecting portion 51f detects the handwriting procedure of the handwriting operation performed on the area represented by the handwriting frame g1 on the operation panel 1a, during a period in which the handwriting frame g1 is displayed on the display portion 1b.

The user performs the handwriting operation with his/her second finger 92 while performing the long-pressing operation on the password input frame g22 with his/her first finger 91 (refer to FIG. 9).

Also in the handwriting detection process in step S206, the handwriting detecting portion 51f detects the handwriting procedure including the trajectory g11 of the handwriting operation and at least one of the time, the speed, and the number of strokes of the handwriting operation.

Further, in step S206, the detection result display control portion 51g causes the display portion 1b to display the result of the detection by the handwriting detecting portion 51f. In the example shown in FIG. 9, the detection result display control portion 51g causes the display portion 1b to display, as the result of the detection by the handwriting detecting portion 51f, the trajectory g11 of each stroke of the handwriting operation, the arrow g12 indicating the moving direction of the trajectory g11 of each stroke, and the stroke order g13 of each stroke.

<Step S207>

Further, the handwriting authentication portion 51j determines whether or not the handwriting procedure detected in step S206 satisfies a predetermined approximation condition with respect to the registered handwriting procedure acquired in step S203, thereby determining whether authentication has succeeded or failed.

For example, the approximation condition includes: a trajectory approximation condition as an approximation condition for the trajectory g11 of each stroke in the handwriting operation; and a temporal approximation condition as an approximation condition for the time of each stroke in the handwriting operation. In addition, regarding the approximation condition, it is an essential condition that the number of strokes of the handwriting operation is the same between the detected handwriting procedure and the registered handwriting procedure.

For example, the trajectory approximation condition includes, as an essential condition, a condition that, between the detected handwriting procedure and the registered handwriting procedure, a deviation of each of a start position and an end position of the trajectory g11 of each stroke in the handwriting operation is within a predetermined allowable positional deviation range.

Likewise, the temporal approximation condition may include, as an essential condition, a condition that, between the detected handwriting procedure and the registered handwriting procedure, a difference in time of each stroke in the handwriting operation is within a predetermined allowable time difference range.

Further, in the present embodiment, each time the trajectory g11 of each stroke in the handwriting operation and one or both of the time and the speed of each stroke are detected by the handwriting detecting portion 51f, the handwriting authentication portion 51j determines whether or not the result of the detection for each stroke satisfies the approximation condition with respect to the registered handwriting procedure 4b (S207). In addition, the handwriting authentication portion 51j determines that the approximation condition is not satisfied when the number of the detected strokes exceeds the number of the strokes in the registered handwriting procedure.

Upon determining that the result of the detection for each stroke does not satisfy the approximation condition with respect to the registered handwriting procedure 4b, the handwriting authentication portion 51j determines that authentication has failed. When the determination results in “authentication failed”, the handwriting authentication portion 51j causes the display portion 1b to display a specified error notification g3, and advances the process to step S201. In this case, the detection result obtained in step S206 is discarded.

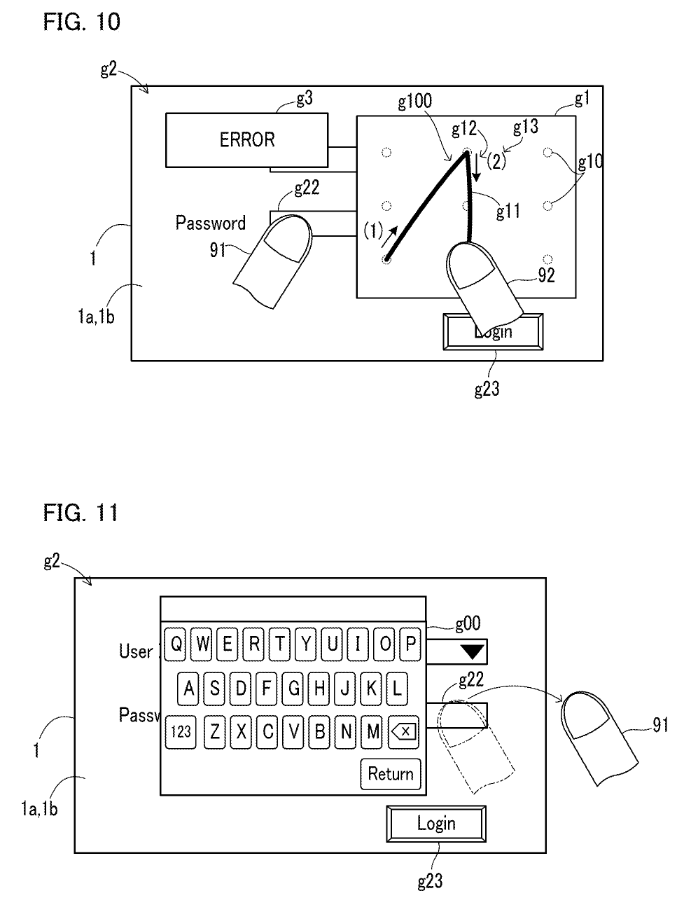

FIG. 10 shows a case where the handwriting authentication portion 51j determines that the trajectory g11 of the second stroke in the detected handwriting procedure does not satisfy the approximation condition with respect to that of the second stroke in the registered handwriting procedure 4b, and causes the display portion 1b to display an error notification g3 on the login screen g2.

The handwriting authentication portion 51j executes, in step S209 described later, a final determination process as to whether authentication has succeeded or failed. This final determination process by the handwriting authentication portion 51j as to whether authentication has succeeded or failed includes a process of determining whether or not the approximation condition regarding the number of strokes of the handwriting operation is satisfied.

<Step S208>

On the other hand, the touch operation detecting portion 51b monitors whether or not the long-pressing operation on the password input frame g22 continues. The touch operation detecting portion 51b allows the process in step S206 by the handwriting detecting portion 51f during a period in which the long-pressing operation on the password input frame g22 continues. The touch operation detecting portion 51b determines that a time point at which the long-pressing operation on the password input frame g22 is no longer detected is an end time point of the handwriting operation.

At least when the long-pressing operation on the password input frame g22 is no longer detected, the handwriting frame display control portion 51e deletes the handwriting frame g1 from the login screen g2 on the display portion 1b, and advances the process to step S209.

Also when the state in which the handwriting operation in the handwriting frame g1 is not detected, continues for a predetermined time or more, the handwriting frame display control portion 51e may delete the handwriting frame g1 from the login screen g2 on the display portion 1b and advance the process to the step S209.

<Step S209 That Follows Step S208>

In step S209 that follows step S208, the handwriting authentication portion 51j executes the final determination process as to whether authentication has succeeded or failed. Specifically, the handwriting authentication portion 51j determines that authentication has succeeded when all the detection results for the respective strokes satisfy the approximation condition with respect to the registered handwriting procedure 4b and the total number of the strokes detected matches the number of the strokes in the registered handwriting procedure; otherwise, the handwriting authentication portion 51j determines that authentication has failed.

Upon finally determining that authentication has succeeded, the handwriting authentication portion 51j advances the process to next step S210; otherwise, the handwriting authentication portion 51j causes the display portion 1b to display a specified error notification and then advances the process to step S201.

<Step S210>

In step S210, the image reading control portion 52 and the image formation control portion 53 each shift to the operating mode, thereby completing the login process. With this, the image processing apparatus 10 becomes capable of executing the image scanning process by the image reading portion 2 and the printing process by the image forming portion 3.

<Step S211>

On the other hand, when the touch operation detecting portion 51b detects the short-pressing operation performed on the password input frame g22 in step S201, the login control portion 51h determines whether or not the selected user ID has already been accepted in the process in step S202. Upon determining that the selected user ID has already been accepted, the login control portion 51h advances the process to next step S212; otherwise, the login control portion 51h causes the display portion 1b to display a specified error notification, and advances the process to step S201.

<Step S212>

In step S212, the character string input control portion 51c causes the display portion 1b to display the virtual keyboard g00 for inputting a character string. FIG. 11 shows the login screen g2 on which the virtual keyboard g00 is displayed by the short-pressing operation performed on the password input frame g22 with the first finger 91.

<Step S213>

Further, the character string input control portion 51c sets the input password in accordance with a key touch operation performed in the area of the virtual keyboard g00 on the operation panel 1a. The key touch operation in the area of the virtual keyboard g00 on the operation panel 1a is an example of a character string input operation.

The process in step S213 is executed when the short-pressing operation on the password input frame g22 is detected. The character string input control portion 51c that performs the process in step S213 is an example of a password input portion that specifies the input password in accordance with the character string input operation performed on the operation panel 1a.

The character string input control portion 51c advances the process to step S201 with the storage of the input password being maintained.

<Step S214>

In step S201, when the touch operation detecting portion 51b detects an operation of touching the “login” icon g23, the login control portion 51h determines whether or not the user ID and the password which are necessary for the password authentication process have already been accepted in the processes in steps S202 and S213.

Upon determining that the user ID and the password necessary for the password authentication process have already been accepted, the login control portion 51h advances the process to next step S215; otherwise, the login control portion 51h causes the display portion 1b to display a specified error notification, and advances the process to step S201.

<Step S215>

In step S215, the password authentication portion 51k executes the password authentication process, and advances the process to step S209. In the password authentication process, the password authentication portion 51k checks the input password set in step S213 against the registered password 4c corresponding to the selected user ID obtained in step S203, thereby determining whether authentication has succeeded or failed. The password authentication portion 51k determines that authentication has succeeded when the input password matches the registered password 4c; otherwise, the password authentication portion 51k determines that authentication has failed.

<Step S209 That Follows Step S215>

In step S209 that follows step S215, the password authentication portion 51k advances the process to step S210 described above when determining that authentication has succeeded in the password authentication process; otherwise, the password authentication portion 51k causes the display portion 1b to display a specified error notification and then advances the process to step S201.

In the present embodiment, the user performs the handwriting operation with his/her second finger 92 in accordance with the pre-registered procedure, while performing long-pressing on the handwriting icon g03 with his/her first finger 91. When the user takes his/her first finger 91 off the handwriting icon g03, the operation for the login process is completed. This operation is simpler than the operation of touching the “login” icon g23 after inputting the password.

The handwriting detecting portion 51f detects the handwriting procedure including the trajectory g11 of the handwriting operation performed on the operation panel 1a, and at least one of the time, the speed, and the number of strokes of the handwriting operation. This handwriting procedure includes a lot of information even if the handwriting operation is an operation of expressing a relatively simple trajectory g11. Therefore, a high-security authentication process is realized by the simple handwriting operation.

The detection result display control portion 51g causes the display portion 1b to display the result of the detection by the handwriting detecting portion 51f. Thus, the user is allowed to perform the handwriting operation required for the authentication process more reliably by operational feeling with his/her second finger 92 and visual recognition of the detected handwriting procedure.

The authentication device 100 is applicable to both the handwriting authentication process and the password authentication process, depending on the preference of the user. In addition, the password input frame g22 of the login screen g2 is shared by the short-pressing operation for inputting the input password and the long-pressing operation for the handwriting operation. Thus, a simple login screen g2 can be adopted.

The detected handwriting procedure and the registered handwriting procedure each include the number of strokes of the handwriting operation performed on the operation panel 1a, and one or both of the operation time for each stroke and the operation speed for each stroke. In this case, the handwriting authentication portion 51j can determine whether or not the detection result of the handwriting procedure for each stroke of the handwriting operation satisfies the approximation condition with respect to the registered handwriting procedure. Thus, it is easy to determine whether or not the approximation condition is satisfied.

In addition, each time the trajectory g11 of each stroke in the handwriting operation and one or both of the time and the speed of each stroke are detected by the handwriting detecting portion 51f, the handwriting authentication portion 51j determines whether or not the detection result for each stroke satisfies the approximation condition with respect to the registered handwriting procedure. Then, upon determining that the detection result for each stroke does not satisfy the approximation condition with respect to the registered handwriting procedure, the handwriting authentication portion 51j determines that authentication has failed.

Therefore, when an inappropriate handwriting procedure is detected in the middle of the handwriting operation, the handwriting authentication portion 51j can promptly provide a determination result of “authentication failed”, without waiting for the end of the handwriting operation.

At least when the long-pressing operation on the operation panel 1a is no longer detected, the handwriting frame display control portion 51e deletes the handwriting frame g1 from the display portion 1b (S208), and the handwriting detecting portion 51f detects the handwriting procedure of the handwriting operation performed on the area represented by the handwriting frame g1 on the touch panel, during a period in which the handwriting frame g1 is displayed on the display portion 1b (S206). Therefore, an extra operation for generating an event to end the handwriting operation, for example, an operation of touching an “operation confirmation” icon displayed in response to the handwriting frame g1, is not necessary.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An authentication device comprising:
an operation panel capable of detecting a multi-touch operation;
a registered handwriting procedure acquiring portion configured to acquire information of a registered handwriting procedure from a storage portion in which the information of the registered handwriting procedure has been stored in advance, the registered handwriting procedure representing a handwriting procedure including a trajectory of a handwriting operation performed on the operation panel and at least one of a time, a speed, and a number of strokes of the handwriting operation;
a long-pressing detecting portion configured to detect a long-pressing operation performed on the operation panel;
a handwriting detecting portion configured to detect the handwriting procedure in the handwriting operation performed on the operation panel, during a period in which the long-pressing operation is continuously detected; and
a handwriting authentication portion configured to determine whether or not the detected handwriting procedure satisfies a predetermined approximation condition with respect to the acquired registered handwriting procedure, thereby determining whether authentication has succeeded or failed.

2. The authentication device according to claim 1, further comprising:
a display portion formed integrally with the operation panel; and
a detection result display control portion configured to cause the display portion to display a result of the detection by the handwriting detecting portion.

3. The authentication device according to claim 1, further comprising:
a registered password acquiring portion configured to acquire a registered password from the storage portion in which the registered password has been stored in advance, the registered password being associated with the information of the registered handwriting procedure;
a display portion formed integrally with the operation panel;
an input frame display control portion configured to cause the display portion to display a password input frame;
a short-pressing operation detecting portion configured to detect a short-pressing operation which is an operation shorter in time than the long-pressing operation, and performed on an area corresponding to the password input frame on the operation panel;
a password input portion configured to specify an input password in accordance with a character string input operation performed on the operation panel, when the short-pressing operation is detected; and
a password authentication portion configured to check the specified input password against the acquired registered password to determine whether authentication has succeeded or failed, wherein
the long-pressing detecting portion detects the long-pressing operation performed on the area corresponding to the password input frame on the operation panel.

4. The authentication device according to claim 1, wherein the handwriting procedure and the registered handwriting procedure each include the number of strokes of the handwriting operation performed on the operation panel, and one or both of an operation time for each stroke and an operation speed for each stroke.

5. The authentication device according to claim 4, wherein
each time the trajectory of each stroke in the handwriting operation and one or both of the time and the speed of the stroke are detected by the handwriting detecting portion, the handwriting authentication portion determines whether or not the detection result for each stroke satisfies the approximation condition with respect to the registered handwriting procedure, and
upon determining that the detection result for each stroke does not satisfy the approximation condition with respect to the registered handwriting procedure, the handwriting authentication portion determines that authentication has failed.

6. The authentication device according to claim 1, further comprising:
a display portion formed integrally with the operation panel; and
a handwriting frame display control portion configured to, when the long-pressing operation is detected, cause the display portion to display a handwriting frame representing an area that accepts the handwriting operation, and delete the handwriting frame from the display portion at least when the long-pressing operation on the operation panel is no longer detected, wherein
the handwriting detecting portion detects the handwriting procedure of the handwriting operation performed on the area represented by the handwriting frame on the operation panel, during a period in which the handwriting frame is displayed on the display portion.

7. An image processing apparatus comprising:
an image processing portion including one or both of an image reading portion configured to read an image of a document sheet and an image forming portion configured to form an image on a sheet; and
an authentication device according to claim 1, configured to determine whether authentication for use of the image processing portion has succeeded or failed.

8. An authentication method comprising the steps of:
acquiring information of a registered handwriting procedure from a storage portion in which the information of the registered handwriting procedure has been stored in advance, the registered handwriting procedure representing a handwriting procedure including a trajectory of a handwriting operation performed on an operation panel capable of detecting a multi-touch operation and at least one of a time, a speed, and a number of strokes of the handwriting operation;
detecting a long-pressing operation performed on the operation panel;
detecting the handwriting procedure in the handwriting operation performed on the operation panel, during a period in which the long-pressing operation is continuously detected; and
determining whether or not the detected handwriting procedure satisfies a predetermined approximation condition with respect to the acquired registered handwriting procedure, thereby determining whether authentication has succeeded or failed.
